(19) United States
(12) Patent Application Publication
(10) Pub. No.: US 2025/0150486 A1
(43) Pub. Date: May 8, 2025

(54) SYSTEMS AND METHODS FOR MANAGING NETWORK FILTERS

(71) Applicant: Level 3 Communications, LLC, Denver, CO (US)

(72) Inventors: William Hoxworth, Westminster, CO (US); Michael Feldpusch, Murrels Inlet, SC (US); Christian Jensen, Westminster, CO (US)

(73) Assignee: Level 3 Communications, LLC, Denver, CO (US)

(21) Appl. No.: 18/919,276

(22) Filed: Oct. 17, 2024

Related U.S. Application Data
(60) Provisional application No. 63/596,396, filed on Nov. 6, 2023.

(51) Int. Cl. H04L 9/40

(52) U.S. Cl. CPC H04L 63/1458; H04L 63/0236; H04L 63/1425

(57) ABSTRACT

A network filter request arbiter is provided. An interface (e.g., user interface and/or programmatic interface, such as an application programming interface (API)), is for configuring and automatically implementing one or more filters in an internal and/or external network. The filters may be used to stop distributed denial of service (DDOS) attacks and/or prevent malicious network traffic from reaching a target network or target device(s) within the target network. Filters implemented in a target network may also be distributed to other (e.g., upstream) networks. The distributed filters may similarly be used to stop DDOS attacks and/or prevent malicious network traffic from being carried by the networks and from reaching a target network or target device(s) within the target network.

### CROSS-REFERENCE TO RELATED APPLICATIONS

This application claims the benefit of U.S. Provisional No. 63/596,396 filed Nov. 6, 2023, entitled “Systems and Methods for Managing Network Filters,” which is incorporated herein by reference in its entirety.

### FIELD

One or more aspects of embodiments according to the present disclosure relate to network management, and more particularly filtering in a network.

### BACKGROUND

To prevent various problems within a network or to prevent issues originating from external networks, filtering may be applied to routers or other devices within the network. For example, filters having specific parameters may be applied to routers within a network to counter distributed denial of service (DDOS) attacks on the network. However, filters that are configured incorrectly may cause more problems than they solve.

It is with respect to this general technical environment that aspects of the present disclosure are related.

### SUMMARY

System and methods for managing network filters are provided.

In an aspect, a first network is provided including a first network device, the first network comprising at least one processor and memory, the memory operatively coupled to the at least one processor and storing instructions that, when executed by the at least one processor, cause the first network to perform a method. In examples, the method includes: providing an interface, the interface configured to receive input from a requester using a second network device of a second network that is external to the first network; receiving, via the interface, a first filter request from the second network device, the first filter request comprising first filter parameters; evaluating the first filter parameters based on one or more filter criteria, the first filter parameters including a target IP address and a source IP address. Based on determining that the first filter parameters pass the evaluation, the method further includes: sending the first filter parameters to the first network device to cause the first network device to implement the first filter parameters for the target IP address; collecting first network information about the first network based on the first filter parameters; and presenting, via the interface, the first network information.

In another aspect, a method is provided, comprising: providing an interface, the interface configured to receive, at a first network device of a first network, input from a requester using a second network device of a second network that is external to the first network; receiving, via the interface, a first filter request from the second network device, the first filter request comprising first filter parameters; evaluating the first filter parameters based on one or more filter criteria, the first filter parameters including a target IP address and a source IP address. Based on determining that the first filter parameters pass the evaluation, the method further includes: sending the first filter parameters to the first network device to cause the first network device to implement the first filter parameters for the target IP address; collecting first network information about the first network based on the first filter parameters; and presenting, via the interface, the first network information.

In another aspect, a method is provided, comprising: providing an interface, the interface configured to receive, at a first network device of a first network, input from a requester; receiving, via the interface, a first filter, the first filter request comprising first filter parameters; evaluating the first filter parameters based on one or more filter criteria, the first filter parameters including a target IP address and a source IP address; based on determining that the first filter parameters pass the evaluation, sending the first filter parameters to the first network device to cause the first network device to implement the first filter parameters for the target IP address; determining whether to send the first filter parameters to a second network that is external to the first network; upon determining to send the first filter parameters to the second network, sending a second filter request to a network filter request arbiter for the second network; and receiving notification whether the first filter parameters have been implemented at the second network.

This summary is provided for convenience and does not limit the scope of the present application in any way.

### BRIEF DESCRIPTION OF THE DRAWINGS

These and other features and advantages of the present disclosure will be appreciated and understood with reference to the specification, claims, and appended drawings wherein:

FIG. 1 is a block diagram of an example system for managing network filters, according to one or more aspects of the present disclosure.

FIG. 2 is a flow chart of an example method for managing network filters, according to one or more aspects of the present disclosure.

FIG. 3 is a flow chart of an example method for managing network filters, according to one or more aspects of the present disclosure.

FIG. 4 is a block diagram of an example operating environment, according to an embodiment of the present disclosure.

### DETAILED DESCRIPTION

The detailed description set forth below in connection with the appended drawings is intended as a description of exemplary embodiments of a system and method for managing FlowSpec or other filtering announcements provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Distributed denial of service (DDOS) attacks are commonly experienced by systems or servers connected to a public network, such as web servers, content delivery network devices, etc. In such an attack, a number of attacking machines may send, to the target system, a high volume of specious requests for service that may, if suitable mitigation measures are not taken, overwhelm the target system and degrade its ability to service legitimate requests. Various methods may be employed for countering distributed denial of service attacks. For example, routers or other devices in the target network may be configured with access control lists (ACLs), which may cause such devices to drop traffic having certain characteristics. Ideally, the characteristics may be selected such that malicious traffic is dropped, while legitimate traffic is allowed to pass to the target. Changing the filtering instructions (e.g., ACLs for the routers) in a network may, however, be a relatively slow process, requiring manual actions/approvals by the operators of the network.

Additionally, while a target network may use filters (e.g., ACLs) to successfully drop malicious traffic, it may be desirable to receive and/or distribute the filters to other connected networks. For example, while some networks may not be the end target of a DDOS attack, such networks may carry network traffic that is part of the DDOS attack that will ultimately be delivered to the target network. Among other things, filtering the network traffic of a DDOS attack at an upstream network may prevent the malicious traffic from being carried unnecessarily to the target network (where it would have been dropped anyway), thus reducing bandwidth usage and saving network resources in multiple networks.

Moreover, customers of a service-provider network may desire to easily filter network traffic at a service-provider level (e.g., before the network traffic reaches their devices or customer network). For example, some customers may lack the personnel and/or equipment needed to block traffic once it reaches the customer's network. However, implementing the filter at the service provider may be a relatively slow process and require a service provider to manually input or approve filter changes within portions of the service provider network.

While implementing and distributing various filters may be desirable (e.g., to stop and/or prevent DDOS attacks), filters may be configured incorrectly. Incorrectly configured filters may not perform as desired (e.g., may not block a DDOS attack) and may disrupt normal network traffic. Therefore, it may be desirable to ensure any filters being implemented and/or distributed are configured correctly. It may also be desirable to keep track of what filters are implemented and in which network/part of a network.

Example systems and methods described herein may manage one or more network filters. For example, systems and methods described herein may provide an interface (e.g., user interface and/or programmatic interface, such as an application programming interface (API)), for configuring and automatically implementing one or more filters in a network. The systems and methods may also record/log the one or more filters implemented in the network and their effect on network traffic. The filters may be used to stop DDOS attacks and/or prevent malicious network traffic from reaching a target network or target device(s) within the target network. Additionally, systems and methods describe herein may automatically distribute filters implemented in a first network to other networks. By the same token, systems and methods described herein may automatically implement filters received in a first network from other networks. The distributed filters may similarly be used to stop DDOS attacks and/or prevent malicious network traffic from being carried by the networks and from reaching a target network or target device(s) within the target network. Further, systems and methods described herein may evaluate filters based on filter criteria to determine if the filters should be implemented or rejected.

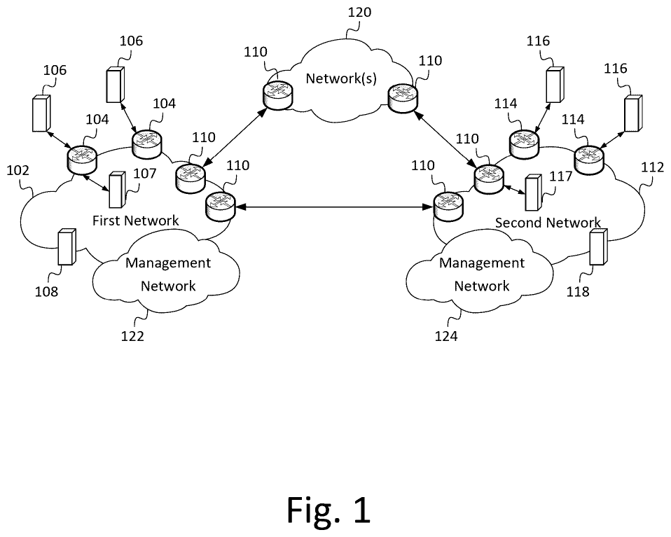

FIG. 1 illustrates block diagram of an example system for managing network filters according to one or more aspects of the present disclosure. A first network 102, which may be a public network or private network, includes a plurality of routers 104. The plurality of routers 104 may send and receive network traffic and may apply one or more filters when processing the traffic. For example, the routers 104 may ingest traffic and discard specious traffic based on (among other things) one or more network filters. The remaining, legitimate traffic may be transmitted via the first network 102 to/from one or more client devices 106. The client devices 106 of the first network 102 may be connected to the routers 104 and may receive data transmitted to them via the first network 102 and/or may be a source of data to be transmitted by the first network 102 (e.g., to a second network 112). In some examples, the routers 104 may include routing devices that implement one or more generic routing encapsulation (GRE) tunnels from the first network 102 to client device(s) 106. In some examples, the GRE tunnels may be instantiated across one or more other network circuits (such as provided by an internet service provider (ISP) for the client devices 106. First network 102 may also include one or more server(s) 107 that are hosted within first network 102 and are reachable via traffic transceived by routers 104. For example, the server(s) 107 may comprise server(s) that host customer content, applications, or other services. First network 102 may also transmit data to, and receive data from, external sources (e.g., network 120) to second network 112, among other possibilities.

Similarly, a second network 112, which may be a public network (such as the Internet) or a separately managed private network, includes a plurality of second routers 114. The plurality of second routers 114 may send and receive network traffic and may apply one or more filters when processing the traffic. For example, the second routers 114 may ingest traffic and discard specious traffic based on (among other things) one or more network filters. The remaining, legitimate traffic may be transmitted via the second network 102 to one or more second client devices 116. The second client devices 116 of the second network 112 may be connected to the second routers 114 and may receive data transmitted to them (e.g., from the first network 102) via the second network 112 and/or may be a source of data to be transmitted by the second network 112 (e.g., to the first network 102). Second network 112 may also include one or more server(s) 117 that are hosted within second network 112 and are reachable via traffic transceived by routers 114.

In some examples, the first network 102 may include a private management network 122 that may provide monitoring and control capabilities for an operator (e.g., via a user interface or API). Further, the second network 112 may include a second private management network 124 that may provide monitoring and control capabilities for an operator (e.g., via a user interface or API). The management networks 122, 124 may be secure networks used for the purpose of management and operation of a production network (e.g., the first network 102, the second network 112). The management network 122 may provide connection and telemetry collection for all the network elements (e.g., routers 104, 110, 114).

In some examples, the first network 102 and the second network 112 communicate with each other though one or more edge routers 110. However, in some examples, the first network 102 and the second network communicate with each other through one or more additional networks 120, which may also include one or more edge routers 110. In similarity with the routers 104 of the first network 102 and the second routers 114 of the second network 112, the edge routers 110 may apply one or more filters when processing network traffic. In some examples, the first network 102 and the second network 112 are different autonomous systems, each comprising its own security domain and identified by an autonomous system (AS) number assigned for use in border gateway protocol (BGP) routing.

Because the first network 102 is in communication with the second network 112, the first network may receive traffic that has first been filtered by the second network 112. For example, the second routers 114 and/or edge routers 110 may filter network traffic before it is sent to the first network 102 from a client device 116 to server 107. Once received by the first network 102, legitimate traffic (which has not been filtered out) may be transmitted to a customer of the first network 102 (e.g., client devices 106) or to end points on the first network (e.g., server 107).

Further, because the second network 112 is in communication with the first network 102, the second network 112 may receive traffic that has first been filtered by the first network 102. For example, the first routers 104 and/or edge routers 110 may filter network traffic before it is sent to the second network from a client device 106 to server 117 or client device 116. Once received by the second network 112, the legitimate traffic may be transmitted to a customer of the second network 112 (e.g., second client device 116 or server 117).

While network filters may be implemented using one or more routers (e.g., 104, 110, 114), in the illustrated example of FIG. 1, a network filter arbiter may be used to perform one or more of creating filters, evaluating filters, changing filters, removing filters, causing filters to be implemented by the one or more routers (e.g., 104, 110, 114), sending filters to other networks to be implemented by the other networks (e.g. via the one or more routers 104, 110, 114), storing information about filters, collecting network information based on filters and their parameters, sending/receiving network information based on the filters and their parameters, and/or other operations regarding filters.

In some examples, the network filter arbiter includes and/or provides an interface (e.g., a user interface or API) through which one or more customers provide input (e.g., requests) regarding one or more filters. Additionally or alternatively, in some examples, the network filter arbiter receives inputs from external sources, such as through an application programing interface (API), an externally implemented user interface, or an online portal request. The network filter arbiter may use inputs from the one or more clients and/or from external sources to perform any of the above-described functions.

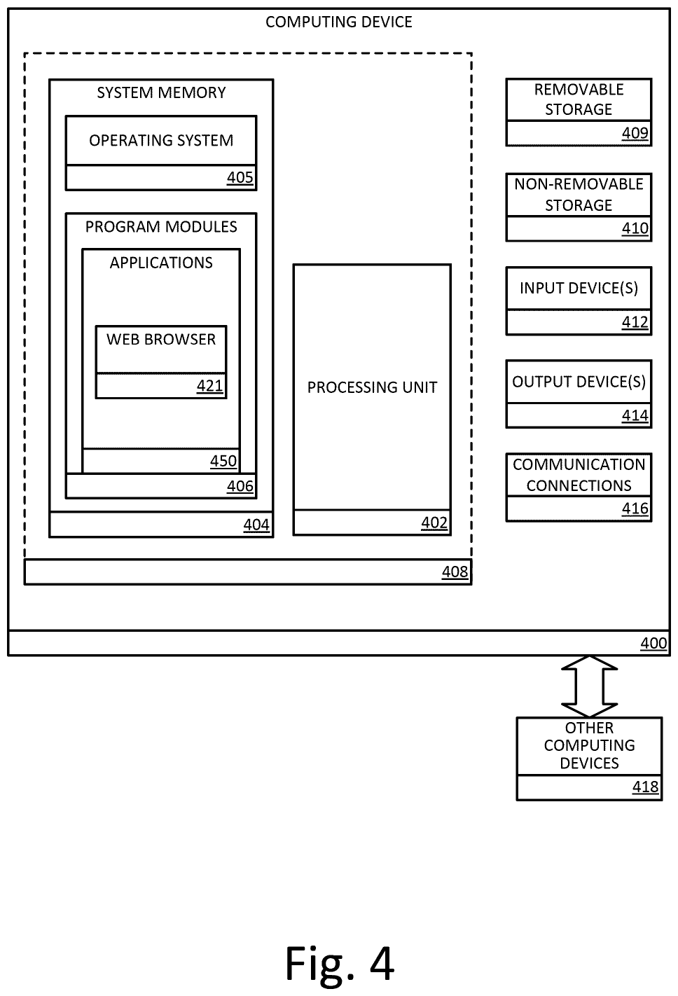

The network filter arbiter may be implemented in software and/or hardware in a variety of devices. For instance, in some examples, the network filter arbiter may be implemented in one or more edge routers 110. The one or more edge routers may include the edge routers 110, which connect one or more networks together, and the routers 104, 116, which provide service to their respective client devices 106, 116. In some examples, the network filter arbiter may be implemented in one or more client devices 106. In some examples, the network filter arbiter may be implemented using a dedicated device or devices, such as the network filter arbiter device 108 of the first network 102, or the network filter arbiter device 118 of the second network 112. In some examples, the network filter arbiter is implemented in one or more private management networks 122, 124. A person having ordinary skill in the art will appreciate the network filter arbiter may be implemented in any computing device (e.g., such as described with respect to FIG. 4) and that the disclosure is not limited to the above examples.

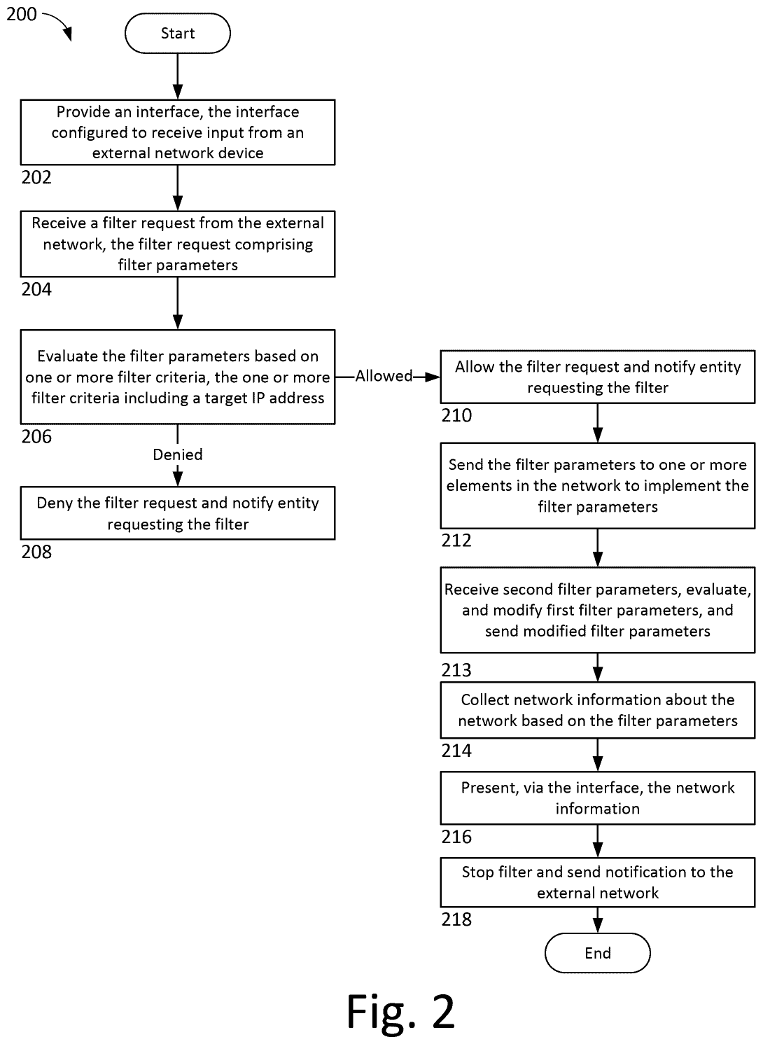

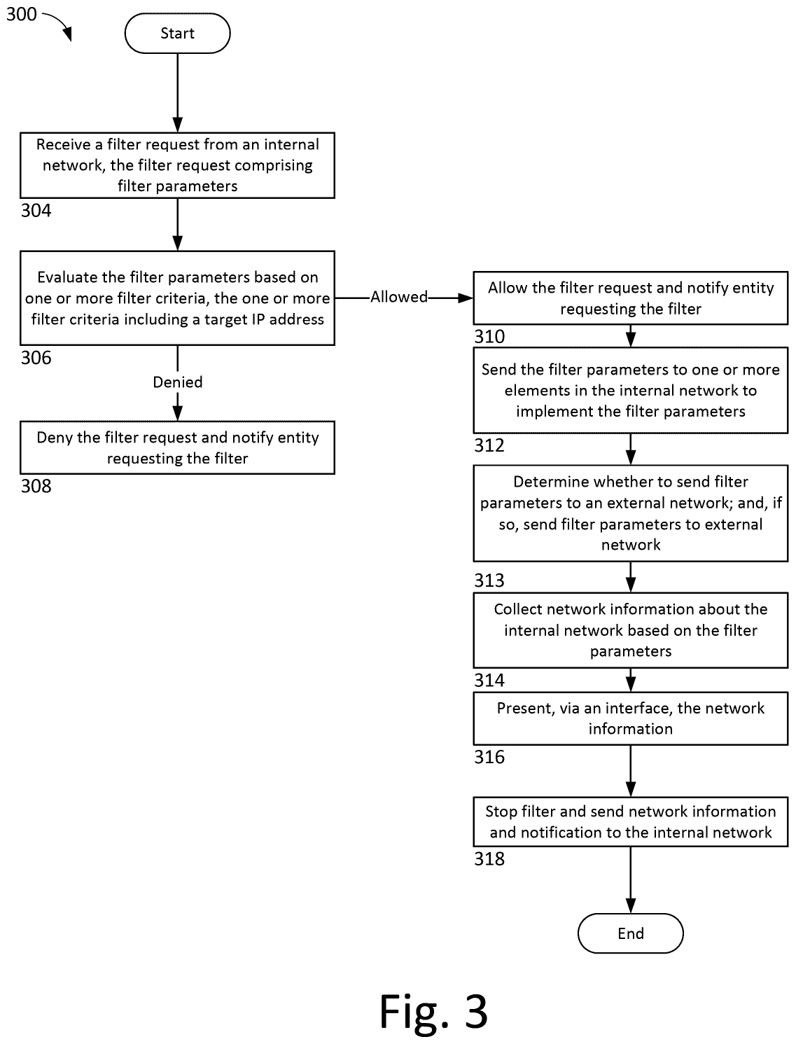

Referring to FIG. 1-FIG. 3, a network filter arbiter may operate according to the example methods described in FIG. 2 and FIG. 3. The example method 200 of FIG. 2 starts at operation 202, whereby the network filter arbiter provides an interface configured to receive input from an external network device. The interface may include any type of interface into which a user may provide input or by which external input may be programmatically received, such as an API. For instance, in some examples, the interface is a web portal or local user-interface application, while in some examples, the interface is an API to programmatically receive input from an external source. In some examples, both a user interface and an API may be used to collect input used in automatically generating and distributing network filter instructions.

In some examples, a user interface may be presented to a user via a display and a user may access the user interface using a variety of different devices such as those including, or connected to, a display. The interface may be implemented or enabled using one or more computing device(s) such as, for example, a client device (e.g., 106, 116), a router (e.g., 104, 110, 114), and/or a network filter arbiter device 108. In some examples, the interface may be implemented using a device that is within a first network 102 owned by a first network operator. In some such examples, a user or external input source may access the interface using a device that is within the first network 102 (e.g., client device 106) and/or using a device that is external to the first network 102 (e.g., second client device 116 or network filter arbiter device 118 of second network 112). Accordingly, the interface may receive input from an internal network device and/or receive input from an external network device. In some examples, operation 202 is optional and the network filter arbiter may operate starting with operation 204.

At operation 204, the network filter arbiter receives a filter request from an external network. As discussed elsewhere herein, the network filter arbiter may be implemented in a variety of devices including routers (e.g., 104, 110, 114), client devices (e.g., 106, 116), and network filter arbiter devices (e.g., 108, 118). The variety of devices may be part a specific network (e.g., a first network 102, a second network 112) whereby they are owned and/or operated by a network operator. Accordingly, the network filter arbiter may be implemented within a device of a first network (e.g., 102) owned and/or operated by a first network operator. The network filter arbiter of the network (e.g., first network 102) may then receive a filter request from a requester using a second computing device via an external network (e.g., second network), which is owned and/or operated by a different network operator. For example, the network filter arbiter may be implemented in a first network device of the first network 102 and receive a filter request from a second network device of the second network 112, with the second network 112 being external to the first network 102. The filter request may be transmitted from the second network 112 to the first network 102 directly using edge routers 110, or indirectly through other networks 120 using edge routers 110. While in operation 204 the network filter arbiter receives a filter request from an external network, the network filter arbiter may similarly receive a filter request from an internal requester from within the first network. For example, the network filter arbiter may be implemented in a first network device of the first network 102 and receive a filter request from a second network device of the first network 102. In some examples, the network filter arbiter may receive filter requests from both external and internal networks. For example, the network filter arbiter may receive a first filter request from an external network and a second, subsequent filter request from an internal network device.

The filter request that the network filter arbiter receives includes one or more filter parameters. The filter request may include any number and variety of filter parameters. For example, the filter parameters may include a target IP address or block of target IP addresses to which the filter will be applied (the target that the filter is intended to protect from receiving specious traffic). The filter parameters may also include the type of filter being implemented such as blocking/allowing network traffic, counting network traffic, and rate limiting network traffic. Additionally, the filter parameters may include a source IP address or block of source IP addresses that will be blocked/allowed, rate limited, or counted by the filter of the filter request. For example, a filter request may include a target IP address (e.g., of a client device and/or server) and a blocking-type filter identifier such that all network traffic being sent from an enumerated source IP address (e.g., another client device, server, and/or router) is blocked from reaching the target IP address. The filter parameters may further include a duration the filter is to be implemented (e.g., a time-to-live for the filter) and a monetary cost of implementing the filter (e.g., to be paid to the network owner that owns/operates the network filter arbiter). A person having ordinary skill in the art will appreciate that other network filter parameters may be used and that this disclosure is not limited to the above examples.

At operation 206, the network filter arbiter evaluates the filter request, including the filter parameters, to ensure the filter request is legitimate and that it will not cause problems with the network or network devices. If the filter request does not pass the evaluation, the method may continue with operation 208. However, if the filter request passes the evaluation, the method may continue with operation 210. In some examples, a portion of the filter request may be denied while another portion of the filter request may be allowed. In some such examples, the method may continue with both operation 208 and operation 210.

The filter request may be evaluated using one or more filter criteria. One or more of the filter criteria may involve determining whether a respective field of the filter request has an acceptable value for the field. The filter criteria may include any type of criteria including a validity/trustworthiness of the requester's IP address, a validity of the target IP address, validity of the source IP address(es), and an ownership of the target IP address(es). For example, if the target IP address is not a valid IP address or the source IP address(es) that would be filtered is/are not a valid IP address, the filter request may be denied as the filter cannot be implemented. In another example, if the customer's (requester's) IP address is identified as an untrusted source, the filter request may be denied as the filter may be illegitimate. Further, ownership of the target IP address by the requester may need to be verified to ensure that the requester is rightfully requesting that traffic to such IP address be affected by the filtering. The filter criteria may also include a prefix length of a source/and or target's IP address, port protocol rules, and rules regarding an origin (e.g., location) of the filter request. In examples, a filter request from an external network may have greater limitations associated with the request when compared to an internal filter request from the network itself (e.g., internal to the network on which the filter request arbiter resides). For example, the filter criteria may further include an evaluation of the number of filters already being implemented for the requester. For example, the ability of some routers (e.g., 104) to apply filtering may be limited, with each such router being capable of applying at most a certain maximum number of filters. Thus, to prevent overloading the router, the number of filters implemented per requester may be limited. Further, the number of filter requests from external networks may be limited more than the number of filter requests from internal requesters.

The network filter arbiter may automatically evaluate filter requests, however, in some examples, one or more filter requests may be manually evaluated. For example, if a filter request is suspected to be illegitimate (e.g., due to any number of filter parameters), the filter request may be forwarded to a human operator to be separately evaluated (e.g., by a network administrator).

By automatically evaluating the filter requests (including from outside of the network on which the network filter arbiter resides), the network filter arbiter enables a network owner to maintain proper operation of network and avoid implementing filters that may cause network issues.

At operation 208, the network filter arbiter denies the filter request and notifies the entity requesting the filter that the filter request was denied. In some examples, the network filter arbiter provides a reason for the filter request being denied. At operation 210, the network filter arbiter allows the filter request and notifies the entity requesting the filter that the filter request was allowed. In examples in which a filter request is partially allowed and partially denied, the network filter arbiter may similarly notify the entity requesting the filter that the filter request was partially allowed and partially denied and specify the extent to which the filter is being implemented and/or the reason for the partial denial.

If the filter request has been allowed, as in operation 210, the network filter arbiter may send (at operation 212) the filter parameters of the filter request, or the filter request itself, to one or more elements in the network in order to implement the filter parameters. The network filter arbiter may communicate with any number of routers, client devices, and network filter arbiter devices to implement the filter parameters. For example, the network filter arbiter may communicate with network devices within the first network 102 including routers 104 used to serve client devices 106, the client devices 106 themselves, the edge routers 110 within the first network 102, devices within the management network 122, and/or the network filter arbiter device 108. In an example, the network filter arbiter may send a target IP address, source IP address(es) to be filtered, a filter type (e.g., a complete block of network traffic from the particular source IP address(es) to the target IP address(es)), and the filter's duration (e.g., TTL) to a customer's router (e.g., 104) so that the customer's router may implement the filter.

In addition to or in lieu of communicating with one or more elements within its own network (e.g., the first network 102), in some examples, if the filter request has been allowed, the network filter arbiter sends the filter parameters of the filter request, or the filter request itself, to one or more elements of an external network (e.g., the second network 112) in order to implement the filter parameters at the second network as well. For example, the network filter arbiter device 108 may communicate with network devices within the second network 112 using edge routers 110. The network devices within the second network 112 include routers 114 used to serve client devices 116, the client devices 116 themselves, the edge routers 110 within the second network 112, devices within the management network 124, and/or the network filter arbiter device 118. In some examples, any filter requests from the first network 102 (whether from filter request arbiter device 108 or another network device of the first network 102) will first be evaluated by a network request arbiter on the second network 112 (such as by network request arbiter device 118) prior to being implemented at the second network 112. In examples, the filter criteria by which the filter request arbiter of the second network 112 evaluates the filter request may be different than the criteria used by the filter request arbiter of the first network 102. As such, a filter request that passes the filter criteria applied by the first filter request arbiter may not pass the filter criteria applied by the second filter request arbiter, or vice versa. In some examples, a filter request from the first network 102 to the second network 112 is made without first being evaluated by the first filter request arbiter (e.g., if the filter is being requested to be implemented only at the second network 112, and not on the first network 102.

In some examples, the network filter arbiter sends the filter request to the external network that provides service to a source IP address or block of source IP addresses that are specified in the filtering request. The external network may subsequently implement the filter and prevent network traffic addressed to the target IP address(es) from such source IP address(es) from being transceived across elements of the external network. For example, a network filter arbiter may receive a filter request that identifies a block of source IP addresses that are part of a DDOS attack on a customer. The network filter arbiter may then send the filter request and/or the filter parameters of the filter request to the external network connecting the block of source IP addresses to the broader network (e.g., the internet). The network devices of the external network may then implement a filter that prevents the block of source IP addresses from sending the specious network traffic of the DDOS attack to the target IP address(es).

In an example, the network filter arbiter device 108 may send a target IP address, a filter type (e.g., complete block, rate limiting, etc.), one or more source IP address(es) (e.g., requested lines of filter), and the filter's duration to the second filter request arbiter device 118. In examples, the filter request may request that a filter be implemented at an edge router (e.g., 110) in the second network 112 that is a part of the path from the second network 112 to a target IP address on the first network 102 (e.g., an IP address for server 107). In such an example, the edge router 110, which is part of an external network (e.g., second network 112), may filter network traffic from the specified source IP address(es) to the target IP address(es) before the traffic reaches the network (e.g., first network 102).

In some examples, parts of the system of FIG. 1 may be owned by different parties. For example, the first network 102 may be owned and/or operated by a first network provider and the second network 110 may be owned and/or operated by a second network provider. In some examples, a network filter arbiter in the first network 102 may be updated by a network filter arbiter in the second network with criteria to apply to a network filter request that originates in the first network but is applicable to network device(s) in the second network. In this manner, a filter request that would not meet the criteria applicable in the second network may be denied without ever being communicated to the second network. In other examples, network requests originating in the first network applicable to network device(s) in the second network may be evaluated by a network filter arbiter in the second network.

At operation 213, flow may continue by receiving a second filter request from the requester, the second filter request comprising second filter parameters. In examples, the second filter parameters are evaluated (e.g., using the then-current filter criteria for the network request arbiter). If the second filter parameters pass the then-current filter criteria, they may be implemented. In examples, this may include modifying the first filter parameters based on the second filter parameters to generate modified filter parameters and sending the modified filter parameters to one or more network elements of the first network.

At operation 214, the network filter arbiter may collect network information about the network based on the filter parameters. For example, the network (e.g., first network 102) may include software data collection elements to collect network statistics about the performance of the filters implementing the filter parameters. At operation 216, the network filter arbiter may present, via the interface, the network information collected in operation 214. The network information may include one or more of a status of the filter and the filter parameters, a number of network communications (e.g., requests) for the target IP address(es) blocked by the filter, and a timing of the network communications. The network information may also include the source IP addresses of the communications (e.g., requests) addressed to the target IP address(es) and blocked by the filter along with the payload of the communications. In some examples, the collected network information is stored in a database connected to the network (e.g., first network 102) that the network filter arbiter may communicate with. In some examples, the collected network information is stored in a network device such as a router (e.g., 104) or network filter arbiter device (e.g., 108). The collected network information may be used by the network filter arbiter to evaluate the operation of the filter and may also be used to stop the filter, update the filter, filter criteria, and filter parameters, and perform other operations relating to the filter.

The network filter arbiter may continuously collect network information to ensure proper operation of the network and/or of the filter. For example, the network filter arbiter may collect network information indicating an DDOS attack from a block of IP addresses has ended and may update the filter to stop blocking traffic from such IP addresses.

Optionally, in some examples, the network filter arbiter may stop the filtering within its internal network and send a notification to the external network that the filter should no longer be implemented, as in operation 218. For example, if the filter is only to be implemented for specific time frame, the network filter arbiter may send a notification that the filter is no longer active at the end of the time frame. Alternatively, a time-to-live or other duration of the filter may be sent with the filter request so that the filter is automatically terminated once the specified duration has expired. In some examples, the network filter arbiter may also make a decision to stop implementing a filter when the network information collected at operation 214 indicates that the filter is no longer warranted (e.g., the number of messages being blocked drops below a certain threshold, indicating the end of a DDOS attack, for example).

FIG. 3 is a flow chart of an example method for managing network filters, according to one or more aspects of the present disclosure. In particular, FIG. 3 may include operations performed by a network filter arbiter and which may occur before or after the operations of FIG. 2. In FIG. 3, the method starts with operation 304, whereby the network filter arbiter receives a filter request from an internal network device with the filter request comprising filter parameters to be applied. For example, the network filter arbiter may be implemented in a first network (e.g., 102) and receive a filter request from a client device 106 within the first network 102. The method may continue with operation 306 whereby the network filter arbiter may evaluate the filter parameters based on one or more filter criteria with the one or more filter criteria including a target IP address and one or more source IP address(es). In examples, the filter criteria applied to the request received from a device within the same network as the network filter arbiter may be different from filter criteria applied to an external request. If the filter parameters do not pass the filter criteria, the filter request may be denied, and the network filter arbiter may notify the user requesting the filter of the denial, as in operation 308. However, if the filter parameters are allowable, the network filter arbiter may allow the filter request and notify the user requesting the filter of the allowability, as in operation 310. Given the filter request is allowed, the network filter arbiter may subsequently send the filter parameters to one or more elements in the internal network to implement the filter parameters as in operation 312. For example, the network filter arbiter may send the filter parameters to a router 104 within the first network 102 and/or to multiple routers 104 within the first network 102.

At operation 313, a determination may be made whether to send the filter parameters to an external network as well. For example, the first network 102 may have a peering relationship with a second network 112 that is a network that provides internet service to one or more source IP addresses that are included in the filter parameters (e.g., source IP addresses to be blocked or rate limited, etc.). A first network request arbiter of the first network 102 may be able to identify that all (or a significant percentage of) traffic from such source IP addresses is received at the first network 102 through the second network 112. In this example, the first request arbiter may make a request for the filter parameters to be implemented in filter(s) on the second network. In some examples, this may include the first network request arbiter (e.g., on device 108) making a filter request to a network request arbiter on the second network 112 (e.g., on device 118) to implement the filter parameters on the second network as well. In examples, this filter request may be made programmatically and automatically without operator input. In other examples, the first network request arbiter may prompt an operator with a suggestion to implement the filter parameters on one or more upstream networks (e.g., second network 112). In examples, operation 313 may also include receiving notification from the second network whether the filter request to the second network has been approved and/or implemented.

To ensure the filter is operating as expected, the network filter arbiter may collect network information about the internal network based on the filter parameters as in operation 314. For example, the network filter arbiter may collect the number of requests a blocked IP address makes to a target IP address. In operation 316, the network filter arbiter may further present the network information collected in operation 314 through a user interface. Accordingly, a customer that initiates the filter request may receive information about the filter they requested to be implemented. In some examples, the network filter arbiter may stop the filter, send a notification to the internal network that the filter is stopped, and send network information to the internal network (e.g., to a customer that initiated the filter request) as in operation 318. For example, the network filter arbiter may send a final report with aggregated network information once the filter has been stopped.

FIG. 4 is a block diagram illustrating physical components (i.e., hardware) of a computing device 400 with which examples of the present disclosure may be practiced. The computing device components described below may be suitable for a computing device(s) implementing one or more of a client device 106, a router 104, second router 114, an edge router 110, network filter arbiter devices 108, 118, or devices of a management network 122, 124 as illustrated in FIG. 1. In a basic configuration, the computing device 400 may include at least one processing unit 402 and a system memory 404. The processing unit(s) (e.g., processors) may be referred to as a processing system. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450 to implement one or more of the systems described above with respect to FIG. 1.

The operating system 405, for example, may be suitable for controlling the operation of the computing device 400. Furthermore, aspects of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the operations of the methods illustrated in FIGS. 2-3. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 400 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports. In examples, communications connections 416 may also include any necessary electrical networks between and among components of the presently described systems.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. Systems depicted as blocks may be communicatively connected to one or more other systems described, whether or not such connection(s) is/are drawn as such. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system for managing network filters comprising:
a first network including a first network device, the first network comprising at least one processor and memory, the memory operatively coupled to the at least one processor and storing instructions that, when executed by the at least one processor, cause the first network to perform a method, the method comprising:
providing an interface, the interface configured to receive input from a requester using a second network device of a second network that is external to the first network;
receiving, via the interface, a first filter request from the second network device, the first filter request comprising first filter parameters;
evaluating the first filter parameters based on one or more filter criteria, the first filter parameters including a target IP address and a source IP address; and
based on determining that the first filter parameters pass the evaluation:
sending the first filter parameters to the first network device to cause the first network device to implement the first filter parameters for the target IP address;
collecting first network information about the first network based on the first filter parameters; and
presenting, via the interface, the first network information.

2. The system of claim 1, wherein the one or more filter criteria include a validity of the target IP address and an ownership of the target IP address.

3. The system of claim 1, wherein the one or more filter criteria includes a prefix length of the target IP address and port protocol rules.

4. The system of claim 1, wherein the source IP address comprises a block of source IP addresses.

5. The system of claim 1, wherein the method further comprises:
receiving a second filter request from the requester after determining the first filter parameters pass the evaluation, the second filter request comprising second filter parameters;
modifying the first filter parameters based on the second filter parameters to generate modified filter parameters; and
sending the modified filter parameters to the first network device.

6. The system of claim 1, wherein the method further comprises sending a command to the first network device to remove the first filter parameters from the first network.

7. The system of claim 1, wherein the first network device comprises a router.

8. The system of claim 1, wherein the first filter parameters include a command for one or more of blocking, allowing, counting, or rate limiting traffic to the target IP address from the source IP address.

9. The system of claim 1, wherein the first filter parameters include a duration after which to remove the first filter parameters from the first network device.

10. The system of claim 1, wherein the source IP address comprises an IP address of a third network device of the second network.

11. The system of claim 1, wherein sending the first filter parameters to the first network device comprises sending the first filter parameters to an edge router connecting the second network device to the first network.

12. The system of claim 1, wherein the first network comprises a first autonomous system (AS) and the second network comprises a second AS.

13. The system of claim 1, wherein the network information comprises one or more of a status of the first filter parameters, a number of requests blocked by the first filter parameters, and a timing of the requests.

14. A method, comprising:
providing an interface, the interface configured to receive, at a first network device of a first network, input from a requester using a second network device of a second network that is external to the first network;
receiving, via the interface, a first filter request from the second network device, the first filter request comprising first filter parameters;
evaluating the first filter parameters based on one or more filter criteria, the first filter parameters including a target IP address and a source IP address; and
based on determining that the first filter parameters pass the evaluation:
sending the first filter parameters to the first network device to cause the first network device to implement the first filter parameters for the target IP address;
collecting first network information about the first network based on the first filter parameters; and
presenting, via the interface, the first network information.

15. The method of claim 14, wherein the one or more filter criteria include a validity of the target IP address and an ownership of the target IP address.

16. The method of claim 14, further comprising:
receiving a second filter request from the requester after determining the first filter parameters pass the evaluation, the second filter request comprising second filter parameters;
modifying the first filter parameters based on the second filter parameters to generate modified filter parameters; and
sending the modified filter parameters to the first network device.

17. The method of claim 14, wherein the first network comprises a first autonomous system (AS) and the second network comprises a second AS.

18. A method, comprising:
providing an interface, the interface configured to receive, at a first network device of a first network, input from a requester;
receiving, via the interface, a first filter, the first filter request comprising first filter parameters;
evaluating the first filter parameters based on one or more filter criteria, the first filter parameters including a target IP address and a source IP address;
based on determining that the first filter parameters pass the evaluation, sending the first filter parameters to the first network device to cause the first network device to implement the first filter parameters for the target IP address;
determining whether to send the first filter parameters to a second network that is external to the first network;
upon determining to send the first filter parameters to the second network, sending a second filter request to a network filter request arbiter for the second network; and
receiving notification whether the first filter parameters have been implemented at the second network.

19. The method of claim 18, wherein determining whether to send the first filter parameters to the second network comprises determining whether a threshold amount of traffic for the target IP address from the source IP address has been received at the first network from the second network.

20. The method of claim 19, wherein the one or more filter criteria include a validity of the target IP address and an ownership of the target IP address.
